(19) United States
(12) Patent Application Publication
(10) Pub. No.: US 2018/0365124 A1
(43) Pub. Date: Dec. 20, 2018

(54) LOG ANALYSIS SYSTEM, LOG ANALYSIS METHOD, AND LOG ANALYSIS PROGRAM

(71) Applicant: NEC CORPORATION, Tokyo (JP)

(72) Inventor: Ryosuke TOGAWA, Tokyo (JP)

(73) Assignee: NEC CORPORATION, Tokyo (JP)

(21) Appl. No.: 16/060,138

(22) PCT Filed: Dec. 8, 2016
(86) PCT No.: PCT/JP2016/005083

§ 371 Date: Jun. 7, 2018

(30) Foreign Application Priority Data
Dec. 14, 2015 (JP) 2015-242945

(51) Int. Cl. G06F 11/34; G06F 11/30

(52) U.S. Cl. CPC G06F 11/3485; G06F 11/3409; G06F 11/3041

(57) ABSTRACT

The present invention provides a log analysis system, a log analysis method, and a log analysis program that can determine whether or not to disregard an abnormal log based on a situation where the abnormal log was output. A log analysis system 100 according to one example embodiment of the present invention includes an anomaly instance information storage unit 173 that records information indicating a situation where a log disregarded based on a past user input was output; and a disregard determination unit 140 that, when information indicating a situation where a log to be determined was output is similar to the information indicating the situation where the disregarded log was output, determines to disregard the log to be determined.

### TECHNICAL FIELD

The present invention relates to a log analysis system, a log analysis method, and a log analysis program for performing log analysis.

### BACKGROUND ART

In general, in a system executed on a computer, logs each including a result of an event, a message, or the like are output from a plurality of devices and programs. A log analysis system detects an abnormal log from the output logs in accordance with a predetermined standard and outputs the detected log as an abnormal log to a user (for example, operator or the like).

Some anomaly logs can be disregarded depending on a situation. In such a case, a user references an anomaly log displayed on a window and inputs an instruction of disregard from the window.

Alternatively, a log analysis system automatically disregards an anomaly log that matches a predetermined rule. As an example of this, the art disclosed in Patent Literature 1 accepts, from a user, designation of a process to be extracted, extracts an error log corresponding to the process, and analyzes the error log using an analysis rule predefined for the process. This enables the user to extract a log according to a particular process designated by the user and disregard other logs.

### CITATION LIST

### Patent Literature

PTL 1: Japanese Patent Application Publication No. 2002-207612

### SUMMARY OF INVENTION

Because of the increasing number of logs due to recent increase in the size of systems, however, it is a great burden on a user to reference all the abnormal logs and input instructions one by one as to whether or not to disregard them.

Further, even when the same abnormal logs are output, there are a case where it can be disregarded and a case where it cannot be disregarded, depending on a situation where the abnormal log was output (that is, a context). Since the art of Patent Literature 1 simply uses a rule as to whether or not a designated process is matched, there is a problem that even an abnormal log output in a context that should not be disregarded may be disregarded.

Since various factors such as a previously output log, performance information, alive monitoring information, or the like are involved in a context according to an abnormal log, it is difficult for a user to manually define a rule including a context.

The present invention has been made in view of the problems described above and intends to provide a log analysis system, a log analysis method, and a log analysis program that can determine whether or not to disregard an abnormal log based on a situation where the abnormal log was output.

A first example aspect of the present invention is a log analysis system including: a storage unit that records information indicating a situation where a log disregarded based on a past user input was output; and a determination unit that, when information indicating a situation where a log to be determined was output is similar to the information indicating the situation where the disregarded log was output, determines to disregard the log to be determined.

A second example aspect of the present invention is a log analysis method including: reading information indicating a situation where a log disregarded based on a past user input was output; and, when information indicating a situation where a log to be determined was output is similar to the information indicating the situation where the disregarded log was output, determining to disregard the log to be determined.

A third example aspect of the present invention is a log analysis program that causes a computer to perform: reading information indicating a situation where a log disregarded based on a past user input was output; and, when information indicating a situation where a log to be determined was output is similar to the information indicating the situation where the disregarded log was output, determining to disregard the log to be determined.

According to the present invention, it is possible to determine whether or not to disregard an abnormal log based on information indicating a situation where a log to be determined was output.

### BRIEF DESCRIPTION OF DRAWINGS

FIG. 1 is a block diagram of a log analysis system according to a first example embodiment.

FIG. 2A is a schematic diagram of an analysis target log according to the first example embodiment.

FIG. 2B is a schematic diagram of a format according to the first example embodiment.

FIG. 3A is a schematic diagram of anomaly instance information according to the first example embodiment.

FIG. 3B is a schematic diagram of context information according to the first example embodiment.

FIG. 4 is a schematic diagram illustrating an action entry window according to the first example embodiment.

FIG. 5 is a schematic diagram illustrating an anomaly instance information selection window according to the first example embodiment.

FIG. 6 is a general configuration diagram of the log analysis system according to the first example embodiment.

FIG. 7 is a diagram illustrating a flowchart of a log analysis method according to the first example embodiment.

FIG. 8 is a block diagram of a log analysis system according to a second example embodiment.

FIG. 9 is a block diagram of a log analysis system according to a third example embodiment.

FIG. 10 is a block diagram of a log analysis system according to a fourth example embodiment.

FIG. 11 is a block diagram of a log analysis system according to each example embodiment.

### DESCRIPTION OF EMBODIMENTS

While example embodiments of the present invention will be described below with reference to the drawings, the present invention is not limited to these example embodiments. Note that, in the drawings described below, those having the same function are labeled with the same reference, and the duplicated description thereof may be omitted.

### First Example Embodiment

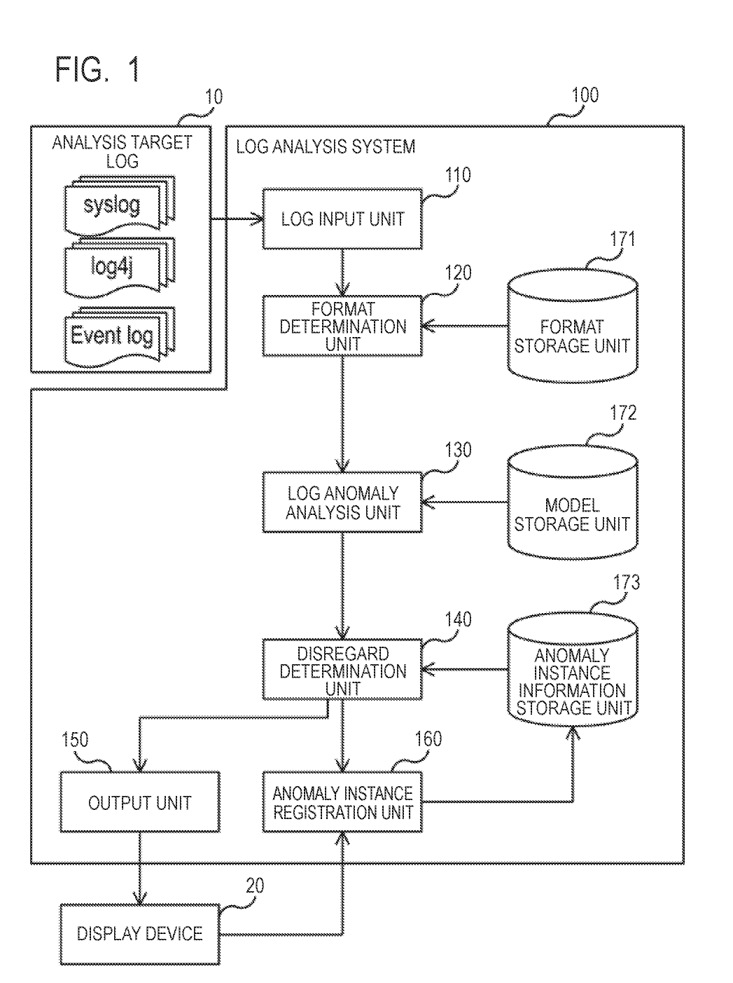

FIG. 1 is a block diagram of a log analysis system 100 according to the present example embodiment. In FIG. 1, the arrows indicate main data flows, and there may be other data flows than is illustrated in FIG. 1. In FIG. 1, each block illustrates a configuration of a function unit rather than a configuration as a unit of hardware (device). Thus, each block illustrated in FIG. 1 may be implemented within a single device or may be implemented separately in multiple devices. Data transaction among blocks may be performed via any means such as a data bus, a network, a portable storage medium, or the like.

The log analysis system 100 has a log input unit 110, a format determination unit 120, a log anomaly analysis unit 130, a disregard determination unit 140, an output unit 150, and an anomaly instance registration unit 160 as a processing unit. Further, the log analysis system 100 has a format storage unit 171, a model storage unit 172, and an anomaly instance information storage unit 173 as a storage unit.

The log input unit 110 acquires an analysis target log 10 of an analysis target period and inputs the analysis target log 10 to the log analysis system 100. The analysis target log 10 may be acquired from the outside of the log analysis system 100 or may be acquired by reading those recorded in advance inside the log analysis system 100. The analysis target log 10 includes one or more logs output from one or more devices or programs. The analysis target log 10 is a log that is represented in any data form (file form), which may be binary data or text data, for example. Further, the analysis target log 10 may be recorded as a table of a database or may be recorded as a text file.

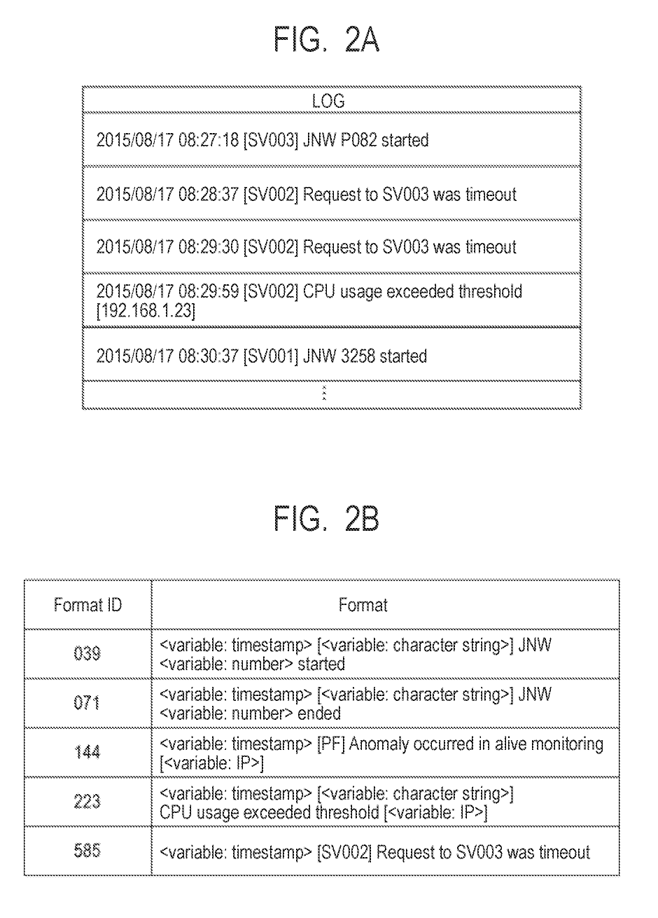

FIG. 2A is a schematic diagram of an exemplary analysis target log 10. The analysis target log 10 in the present example embodiment includes one or more any number of logs in a unit of a single log output from a device or a program. A log may be a single row of a character string or multiple rows of character strings. That is, the analysis target log 10 designates the whole logs included in the analysis target log 10, and a log denotes a single log picked out from the analysis target log 10. Each log includes a timestamp, a message, and the like. In the log analysis system 100, a broad range of types of logs can be a target of analysis without being limited to a particular type of logs. For example, logs such as a syslog, an event log, or the like that record a message output from operating system or an application can be used as the analysis target log 10.

The format determination unit 120 is a variable extraction unit that determines which format prerecorded in the format storage unit 171 each log included in the analysis target log 10 conforms to and that uses the conforming format to separate each log into a variable part and a constant part. A format is a form of a log that is predetermined based on a log property. A log property includes such a nature that is likely or unlikely to vary among logs that are similar to each other, or such a nature that a character string which can be seen as a part that is likely to vary is described in a log. A variable part is a changeable part in a format, and a constant part is unchanging part in a format. A value (including a number, a character string, and other data) of a variable part in the input log is referred to as a variable value. The variable part and the constant part are different among each format. Thus, a part defined as a variable part in a format may be defined as a constant part in another format, and vice versa.

FIG. 2B is a schematic diagram of an exemplary format recorded in the format storage unit 171. A format includes a character string representing a format associated with a unique ID. The format defines a variable part by describing a predetermined identifier in the changeable part of a log and defines a part other than the variable part of the log as a constant part. As an identifier of a variable part, for example, “<variable: timestamp>” indicates a variable part representing a timestamp, “<variable: character string>” indicates a variable part representing any character string, “<variable: number>” indicates a variable part representing any number, and “<variable: IP>” indicates a variable part representing any IP address. An identifier of a variable part is not limited to the above and may be defined by any method such as normalized expression, a list of possible values, or the like. Further, a format may be formed of only the constant part without including a variable part or may be formed of only the variable part without including a constant part.

For example, the format determination unit 120 determines that a log on the fifth row of FIG. 2A conforms to a format whose ID is 223 in FIG. 2B. The format determination unit 120 then processes the log based on the determined format and determines the timestamp “2015/08/17 08:29:59”, the character string “SV002”, and the IP address “192.168.1.23” as variable values.

While represented by a list of character strings for better visibility in FIG. 2B, a format may be represented in any data form (file form), and may be binary data or text data, for example. Further, a format may be recorded in the format storage unit 171 as a text file or may be recorded in the format storage unit 171 as a table of a database.

The log anomaly analysis unit 130 determines whether or not the log whose format has been determined by the format determination unit 120 is abnormal based on a model prerecorded in the model storage unit 172. A model is a definition of normal behavior of a log. One or more models are prerecorded in the model storage unit 172. In the present example embodiment, a model is defined by a combination of a format and a variable value regarded as normal. The model means that the variable values of a number is within a predetermined range in a format, that the variable value of a character string has been registered in a format, or the like, for example. A model is not limited to the above and may be of any definition.

When an input log does not conform to any of the models in the model storage unit 172, the log anomaly analysis unit 130 determines that the log is abnormal. On the other hand, when an input log conforms to any of the models in the model storage unit 172, the log anomaly analysis unit 130 determines that the log is a normal log.

The disregard determination unit 140 performs determination as to whether or not to disregard an abnormal log output from the log anomaly analysis unit 130 based on anomaly instance information recorded in the anomaly instance information storage unit 173. The anomaly instance information is information indicating a situation (that is, a context) where an abnormal log disregarded in the past based on a user input was output.

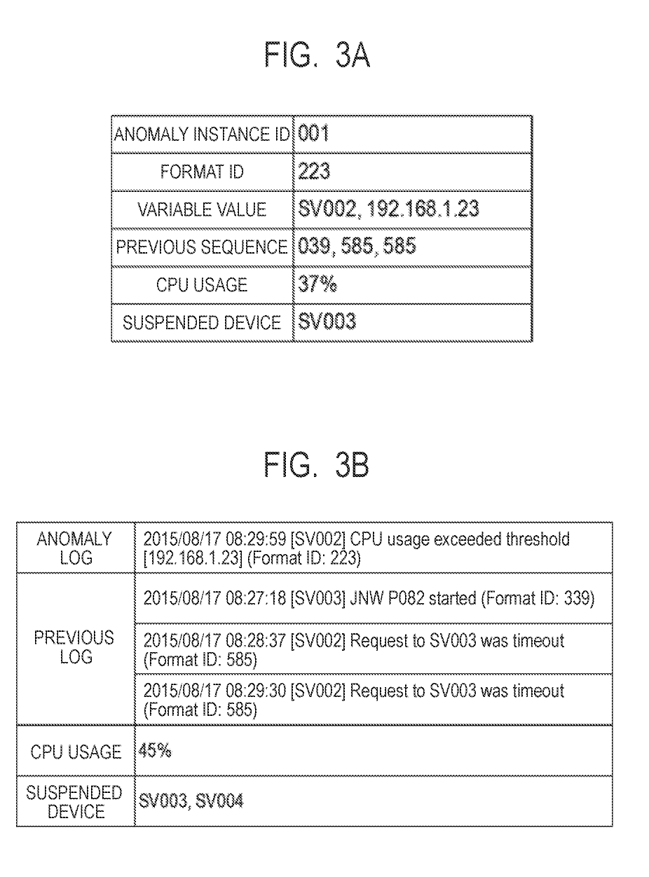

FIG. 3A is a schematic diagram of exemplary anomaly instance information. Anomaly instance information includes a format ID that is an identifier of a format and a variable value applied to the format that are associated with an anomaly instance ID that is a unique identifier. A format ID and a variable value are information contained in an abnormal log itself to be determined by the disregard determination unit 140. A format ID indicates which format an abnormal log corresponds to, and a variable value indicates a specific variable value that an abnormal log has in the format.

Furthermore, anomaly instance information includes a previous sequence, a CPU usage, and a suspended device that are associated with an anomaly instance ID. A previous sequence, a CPU usage, and a suspended device are information on an environment where an abnormal log to be determined by the disregard determination unit 140 was output.

The previous sequence indicates sequence information, which is a list of format IDs of logs output within a predetermined time period (for example, within five minutes) before the time when an abnormal log was output. A sequence is a permutation or a combination of format IDs in the list. The anomaly instance information in FIG. 3A indicates that logs whose format IDs are 039, 585, and 585 sequentially appear as a previous sequence before an abnormal log. Here, sequence information does not include, but may include, a format ID of the abnormal log itself. Without limited to logs on or before a predetermined time when the abnormal log is output, sequence information may be acquired from logs within a predetermined time period before or after the time as a reference. Further, sequence information may be acquired from a predetermined number of (for example, three) logs without limited to logs within a predetermined time period.

The CPU usage indicates performance information, which is a usage of a CPU of a device associated with the abnormal log at the time when an abnormal log was output. The anomaly instance information in FIG. 3A indicates that the CPU usage at the time when the abnormal log was output is 37%. A device associated with an abnormal log (a server, a network device, a virtual machine, or the like) is a device that has output an abnormal log or a device connected to a device that has output an abnormal log, for example. When a plurality of devices associated with an abnormal log, the average value of the CPU usages of the plurality of devices may be used as a CPU usage, or a list of CPU usages of the plurality of devices may be used. Further, any information on the performance of a device such as a usage of memory, traffic of a network, the combination thereof, or the like may be used as performance information, without limited to the CPU usage.

The suspended device indicates alive monitoring information, which is a list of suspended devices or programs at the time when an abnormal log was output. The anomaly instance information in FIG. 3A indicates that a device having an identifier of SV003 (here, a server name) is suspended. Any information on the operating state of a device or a program such as a list of running devices or programs may be used as alive monitoring information, without limited to the suspended device. A target of alive monitoring information may be any device or program such as a device connected to a device via a cable or a network, a network device connected between devices, a running virtual machine or program, or the like.

Further, anomaly instance information may include an occurrence ratio of a format. The occurrence ratio of a format is a ratio of format IDs of logs output within a predetermined time period (for example, within five minutes) with respect to the time when an abnormal log was output. The occurrence ratio of a format may or may not include an abnormal log itself. For example, in FIG. 3A, the occurrence ratios of a format can be calculated as around 33% for the format ID of 039 and around 66% for the format ID of 585 within five minutes before the time when the abnormal log was output.

Further, anomaly instance information may include an occurrence ratio of a sequence. The occurrence ratio of a sequence is a ratio of sequences (the permutation or the combination of format IDs) of logs output within a predetermined time period (for example, within five minutes) with respect to the time when an abnormal log was output. The occurrence ratio of formats may or may not include an abnormal log itself. For example, in FIG. 3A, the occurrence ratio of a sequence can be calculated as around 50% for the sequence including the format IDs of 039 and 585 in this order and around 50% for the sequence including the format IDs of 585 and 585 in this order within five minutes from the time when the abnormal log was output.

Without limited to the whole of the above information, at least a part of the above information may be used as anomaly instance information.

Anomaly instance information is generated based on a situation where an abnormal log that was disregarded based on a user input in the past was output and recorded in the anomaly instance information storage unit 173 by the anomaly instance registration unit 160 described later. By using such anomaly instance information, the disregard determination unit 140 can determine whether or not to perform automatic disregarding based on a situation where an abnormal log is output (context).

The disregard determination unit 140 collects information indicating a situation where an abnormal log to be determined is output (referred to as context information). FIG. 3B is a schematic diagram of exemplary context information. The items of the context information correspond to the items of anomaly instance information generated from the past abnormal logs described above. The disregard determination unit 140 collects context information from a device outputting an abnormal log and a device associated with an abnormal log.

The context information according to the present example embodiment includes abnormal log to be determined, a log output within a predetermined time period (for example, within five minutes) before the time when the abnormal log was output (referred to as a previous log). The previous log is not limited to a log occurring on or before the time when an abnormal log was output and may be a log occurring within a predetermined time period before or after the time as a reference. Note that, while a format ID of a format determined by the format determination unit 120 is appended to each log with parenthesis for reference, the format ID itself is not included in a log. Furthermore, the context information according to the present example embodiment includes a CPU usage of a device associated with the abnormal log at the time when the abnormal log was output and a suspended device at the time.

The disregard determination unit 140 determines which anomaly instance information recorded in the anomaly instance information storage unit 173 the context information generated from an abnormal log to be determined is similar to. In the present example embodiment, the disregard determination unit 140 determines that the context information is similar to the anomaly instance information if all the following conditions (1) to (5) are satisfied.

(1) A Format ID of an Abnormal Log in Context Information Matching a Format ID of an Anomaly Instance Information

Specifically, if the format ID of the anomaly log of the context information is identical to the format ID of the anomaly instance information, the disregard determination unit 140 determines that there is a matching.

(2) Each Variable Value in an Abnormal Log in Context Information being Similar to Each Variable Value in Anomaly Instance Information

Specifically, when a variable value is a character string and if a variable value in an abnormal log in context information matches a predetermined rule with respect to a variable value in anomaly instance information (for example, it matches characters other than a tail character or is defined as a combination of a certain character string and a changeable number), the disregard determination unit 140 determines that there is a similarity. Further, when a variable value is a number, if a variable value in an abnormal log in context information is within a predetermined range (for example, −10% to +10%) with respect to a variable value in anomaly instance information, the disregard determination unit 140 determines that there is a similarity.

(3) A Previous Log in Context Information Matching a Previous Sequence in Anomaly Instance Information

Specifically, if the permutation or the combination of the format IDs of the previous log in context information matches the permutation or the combination of the format IDs of the previous sequence in anomaly instance information, the disregard determination unit 140 determines that there is a matching. Note that the disregard determination unit 140 may determine that there is a matching when a part instead of all of the pervious logs in context information are identical to the previous sequence.

(4) A CPU Usage in Context Information being Similar to a CPU Usage in Anomaly Instance Information

Specifically, if a CPU usage in context information is within a predetermined range (for example, −10% to +10%) with respect to a CPU usage in anomaly instance information, the disregard determination unit 140 determines that there is a similarity.

(5) A Suspended Device in Context Information being Similar to a Suspended Device in Anomaly Instance Information

Specifically, if at least a part of the suspended devices in context information is identical to a suspended device in anomaly instance information, the disregard determination unit 140 determines that there is a similarity. Note that the disregard determination unit 140 may determine that there is a similarity when all instead of a part of the suspended devices in the context information are identical to the suspended devices in the anomaly instance information.

The disregard determination unit 140 may determine that the context information is similar to the anomaly instance information if some instead of all of the conditions (1) to (5) are satisfied. Further, alternatively or in addition to the conditions (1) to (5), an occurrence ratio of a format or an occurrence ratio of a sequence described above may be used as the condition.

When the context information generated from an abnormal log to be determined is determined to be similar to any abnormal instance information recorded in the anomaly instance information storage unit 173, the disregard determination unit 140 disregards the abnormal log. Disregarding an abnormal log is not to perform output of the abnormal log from the output unit 150 or the like and not to ask a user for an action. On the other hand, when the context information generated from an abnormal log to be determined is determined to be not similar to any of the abnormal instance information recorded in the anomaly instance information storage unit 173, the disregard determination unit 140 inputs the abnormal log in the output unit 150.

The output unit 150 outputs an abnormal log determined to be not similar to any of the anomaly instance information by the disregard determination unit 140. In the present example embodiment, the output unit 150 outputs the abnormal log on a display device 20, and the display device 20 displays the abnormal log as an action input window image to a user. The output unit 150 may output an alert by generating a sound or a light or displaying a predetermined message on the display device 20 together with the abnormal log.

The display device 20 has a display unit such as a liquid crystal display, a cathode ray tube (CRT) display, or the like used for displaying an image. Further, the display device 20 has an input device such as a keyboard, a mouse, a touch panel, or the like and accepts input from a user. The display device 20 then inputs, to the log analysis system 100, the action content for each abnormal log input from the user.

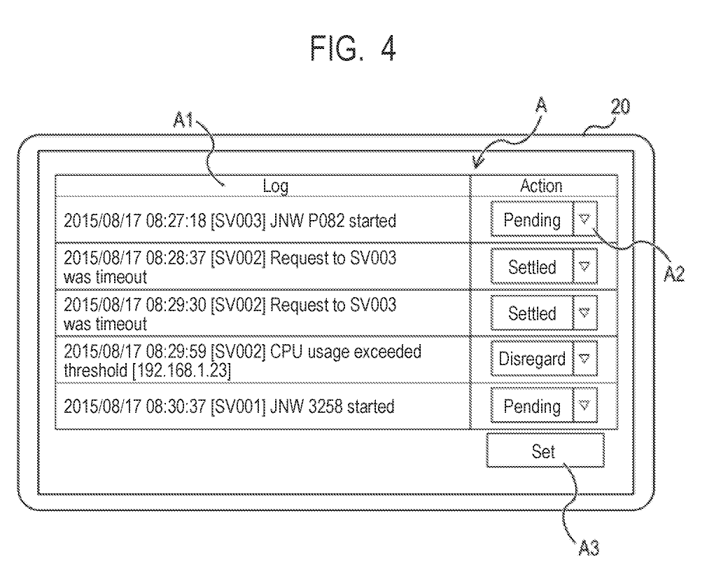

FIG. 4 is a schematic diagram illustrating an exemplary action input window A using the display device 20. The action input window A illustrated in FIG. 4 includes anomaly logs A1 output from the log anomaly analysis unit 130, a selection box A2 that designates action content to each abnormal log A1, and a setting button A3 that registers the selected content. The selection box A2 includes, as the action content to the abnormal log A1, “Disregard” that indicates disregarding the abnormal log A1, “Settled” that indicates that some action has been made to the abnormal log A1, and “Pending” that indicates that determination of action has not yet been made, for example.

The user uses the input device to select action content on the selection box A2 for each abnormal log A1 and then press down the setting button A3. Then, the log analysis system 100 records the action content selected on the selection box A2 in association with each abnormal log A1. Furthermore, when the action content selected on the selection box A2 indicates disregarding the abnormal log A1, the anomaly instance registration unit 160 described later generates anomaly instance information based on the abnormal log A1 and registers it in the anomaly instance information storage unit 173.

The action input window A illustrated in FIG. 4 is an example, and any method may be used as long as the user can input action content for an abnormal log.

The anomaly instance registration unit 160 generates anomaly instance information from the abnormal log determined by the user to be disregarded and records it in the anomaly instance information storage unit 173. Specifically, first, the anomaly instance registration unit 160 reads the action content input by the user using the input device for the abnormal log to be determined. When the action content input by the user indicates disregarding an abnormal log to be determined, the anomaly instance registration unit 160 collects context information on the anomaly log to be determined in a similar manner to the disregard determination unit 140 described above. The anomaly instance registration unit 160 generates anomaly instance information based on the collected context information and registers it to the anomaly instance information storage unit 173.

As an example, a method in which the anomaly instance registration unit 160 generates anomaly instance information illustrated in FIG. 3A based on context information illustrated in FIG. 3B will be described below. An anomaly instance ID of the anomaly instance information is generated by acquiring any character string or number that is unregistered in the anomaly instance information storage unit 173. The format ID and the variable value in the anomaly instance information are generated by using a determination result obtained by the format determination unit 120 to extract the format ID and the variable value (however, a timestamp is excluded here) from an abnormal log of the context information. The previous sequence of the anomaly instance information is generated by using a determination result obtained by the format determination unit 120 to extract a format ID from the previous log of the context information. The CPU usage and the suspended device of the anomaly instance information are the same as the CPU usage and the suspended device of the context information. A method of generating anomaly instance information based on context information is not limited thereto, and any rule such as excluding a value, converting a value, a patterning a value, or the like may be used.

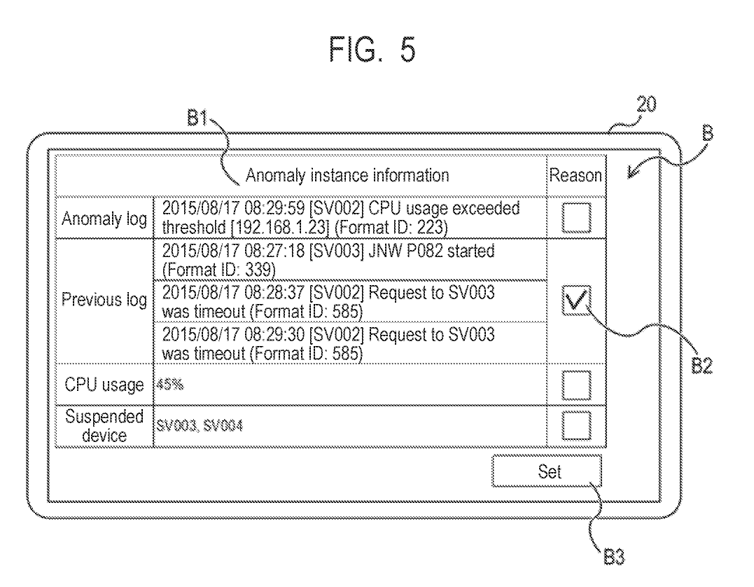

Further, the anomaly instance registration unit 160 may select anomaly instance information based on an input operation by the user as described below. When action content of disregarding an abnormal log is input by the user on the action input window A described above, the anomaly instance registration unit 160 first generates a provisional anomaly instance information based on the abnormal log. Next, the anomaly instance registration unit 160 presents the provisional anomaly instance information to the user via the display device 20. FIG. 5 is a schematic diagram illustrating an exemplary anomaly instance information selection window B using the display device 20. The anomaly instance information selection window B illustrated in FIG. 5 includes anomaly instance information B1 generated by the anomaly instance registration unit 160, checkboxes B2 used for selecting whether or not each information included in the anomaly instance information B1 (abnormal log, previous log, performance information, and alive monitoring information) is information forming a reason in determination of the action content, and a setting button B3 used for registering the selected content. When the checkbox B2 is on, this indicates that the corresponding information is selected, and when the checkbox B2 is off, this indicates that the selection of the corresponding information is cancelled.

The user selects information forming a reason in determining the action content in the anomaly instance information selection window B using the checkbox B2 and presses down the setting button B3. Then, the anomaly instance registration unit 160 registers the anomaly instance information selected based on the user input to the anomaly instance information storage unit 173. For example, when only the previous log is selected out of the anomaly instance information, the anomaly instance registration unit 160 may delete other information that is not selected, such as performance information or alive monitoring information, from the anomaly instance information. Alternatively, when the disregard determination unit 140 checks the past anomaly instance, the anomaly instance registration unit 160 may define the above-described other information in the anomaly instance information so as not to define it as a condition of similarity determination.

The anomaly instance information selection window B illustrated in FIG. 5 is an example, and any method may be used as long as the user can input selection content of anomaly instance information. For example, the checkbox B2 may be provided for each variable value included in an abnormal log to accept selection by a user. Further, the checkbox B2 may be provided for each log included in the previous log to accept selection by a user.

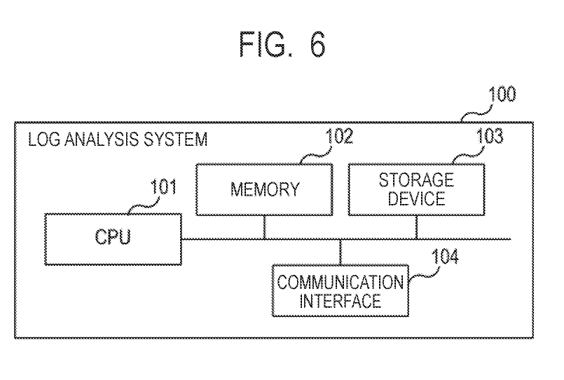

FIG. 6 is a general configuration diagram illustrating an exemplary device configuration of the log analysis system 100 according to the present example embodiment. The log analysis system 100 has a central processing unit (CPU) 101, memory 102, a storage device 103, and a communication interface 104. The log analysis system 100 may be connected to the display device 20 via the communication interface 104 or may include the display device 20. The log analysis system 100 can be a standalone device or may be integrally configured with another device.

The communication interface 104 is a communication unit that transmits and receives data and is configured to be able to perform at least one of the communication schemes of wired communication and wireless communication. The communication interface 104 includes a processor, an electric circuit, an antenna, a connection terminal, or the like required for the above communication scheme. The communication interface 104 is connected to a network using the above communication scheme in accordance with signals from the CPU 101 for communication. For example, the communication interface 104 externally receives an analysis target log 10.

The storage device 103 stores a program executed by the log analysis system 100, data resulted from processing by the program, or the like. The storage device 103 includes a read only memory (ROM) that is dedicated to reading, a hard disk drive or a flash memory that is readable and writable, or the like. Further, the storage device 103 may include a computer readable portable storage medium such as a CD-ROM. The memory 102 includes a random access memory (RAM) or the like that temporarily stores data being processed by the CPU 101 or a program and data read from the storage device 103.

The CPU 101 is a processor as a processing unit that temporarily stores transient data used for processing in the memory 102, reads a program stored in the storage device 103, and performs various processing operations such as calculation, control, determination, or the like on the transient data in accordance with the program. Further, the CPU 101 stores data of a process result in the storage device 103 and also transmits the data of the process result externally via the communication interface 104.

The CPU 101 in the present example embodiment functions as the log input unit 110, the format determination unit 120, the log anomaly analysis unit 130, the disregard determination unit 140, the output unit 150, and the anomaly instance registration unit 160 of FIG. 1 by executing a program stored in the storage device 103. Further, the storage device 103 in the present example embodiment functions as the format storage unit 171, a model storage unit 172, and the anomaly instance information storage unit 173 of FIG. 1.

The log analysis system 100 is not limited to the specific configuration illustrated in FIG. 6. The log analysis system 100 is not limited to a single device and may be configured such that two or more physically separated devices are connected by wired or wireless connection. Respective units included in the log analysis system 100 may be implemented by electric circuitry, respectively. Electric circuitry here is a term conceptually including a single device, multiple devices, a chipset, or a cloud.

Further, at least a part of the log analysis system 100 may be provided in a form of Software as a Service (SaaS). That is, at least a part of the functions for implementing the log analysis system 100 may be performed by software executed via a network.

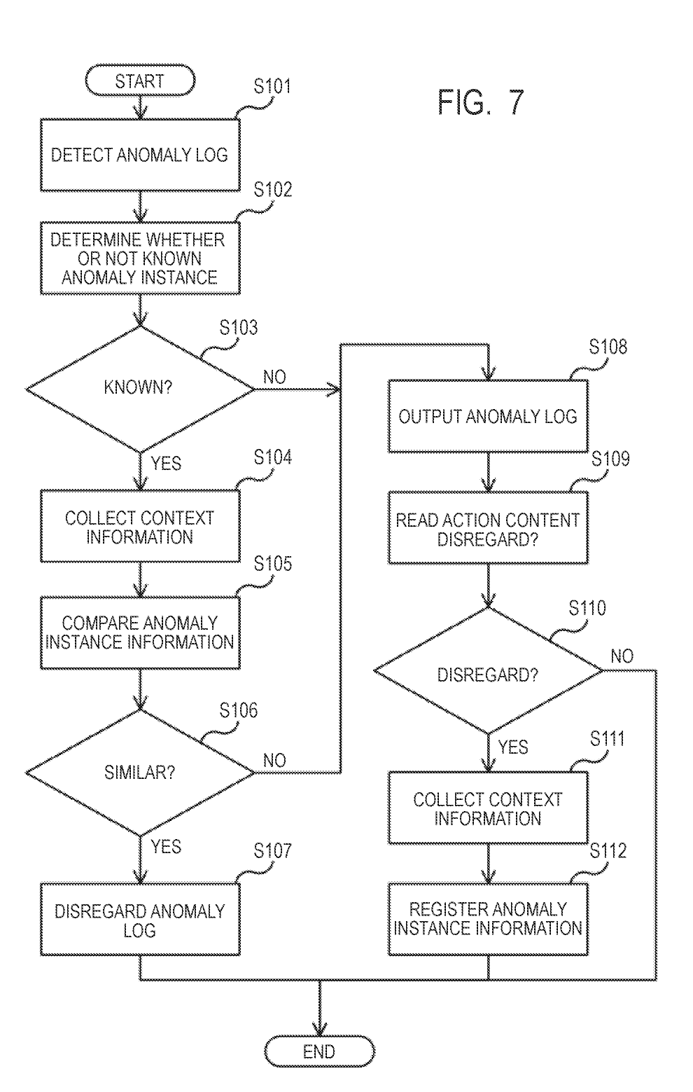

FIG. 7 is a diagram illustrating a flowchart of a log analysis method according to the present example embodiment. First, the format determination unit 120 determines which format prerecorded in the format storage unit 171 is matched to each log included in the analysis target log 10, and the log anomaly analysis unit 130 determines whether or not each log of the analysis target log 10 whose format has been determined is abnormal based on the model prerecorded in the model storage unit 172 (step S101). When the input log does not conform to any of the models in the model storage unit 172, the log anomaly analysis unit 130 determines that the log is an abnormal log. On the other hand, when the input log conforms to any model in the model storage unit 172, the log anomaly analysis unit 130 determines that the log is a normal log.

The subsequent process is performed designating each of abnormal logs acquired in step S101 to be determined. A plurality of abnormal logs may be processed in parallel, or after a process of one abnormal log is finished, another abnormal log may be processed.

The disregard determination unit 140 determines whether or not an abnormal log to be determined corresponds to a known anomaly instance based on anomaly instance information recorded in the anomaly instance information storage unit 173 (step S102). Specifically, when there is a format ID that matches a format ID of an abnormal log in the format IDs of anomaly instance information recorded in the anomaly instance information storage unit 173, the disregard determination unit 140 determines that the abnormal log to be determined corresponds to a known anomaly instance, otherwise, determines that it does not correspond to any known anomaly instance. Further, whether or not the abnormal log to be determined corresponds to a known anomaly instance may be determined based on whether or not a variable value in the abnormal log matches or is similar to a variable value in the anomaly instance information, in addition to whether or not the format ID is matched.

If the abnormal log to be determined in step S102 corresponds to a known anomaly instance (step S103, YES), the disregard determination unit 140 collects context information on the abnormal log to be determined (step S104). In the present example embodiment, the context information includes the abnormal log itself, a previous log, a CPU usage, and a suspended device. Specifically, out of logs whose formats have been determined by the format determination unit 120 (that is, abnormal logs and normal logs), the disregard determination unit 140 acquires, as the previous log, a log output within a predetermined time period (for example, within five minutes) before the time when the abnormal log was output. The time when the abnormal log was output is acquired from a portion of the timestamp in the abnormal log, for example. Further, the disregard determination unit 140 acquires, as a CPU usage, the usage of a CPU of a device that output the abnormal log at the time when the abnormal log was output, from a not shown performance information monitoring system (device or program). Further, the disregard determination unit 140 acquires, as a suspended device, a list of suspended devices or programs at the time when the abnormal log was output, from a not shown alive monitoring system (device or program).

Next, the disregard determination unit 140 compares each anomaly instance information recorded in the anomaly instance information storage unit 173 with the context information on the abnormal log acquired in step S104 (step S105). As described above, if the abnormal log, the previous log, the CPU usage, and the suspended device in the context information satisfy a predetermined condition for any anomaly instance information recorded in the anomaly instance information storage unit 173, the disregard determination unit 140 determines the context information on the abnormal log to be determined is similar to the anomaly instance information.

If the context information on the abnormal log to be determined in step S105 is determined to be similar to any anomaly instance information recorded in the anomaly instance information storage unit 173 (step S106, YES), the disregard determination unit 140 disregards the abnormal log to be determined (step S107). The process on the abnormal log to be determined then ends.

If the abnormal log to be determined in step S102 does not correspond to a known anomaly instance (step S103, NO), or if the context information on the abnormal log to be determined in step S105 is determined to be not similar to any of the anomaly instance information recorded in the anomaly instance information storage unit 173 (step S106, NO), the output unit 150 outputs the anomaly log to the user by using the display device 20 (step S108).

The user references the abnormal log output in step S108 and inputs action content by using the input device. The log analysis system 100 performs the action in accordance with the action content input from the user. For example, the abnormal log is deleted from the display device 20 as the abnormal log being disregarded when the action content is “disregard”, and display of the abnormal log on the display device 20 is continued when the action content is “pending”. Further, the log analysis system 100 may perform a predetermined process in accordance with other input action content.

Next, the anomaly instance registration unit 160 reads the action content input from the user (step S109). Then, if the action content read in step S109 indicates disregarding of the abnormal log (step S110, YES), the anomaly instance registration unit 160 collects context information on the abnormal log to be determined (step S111). The anomaly instance registration unit 160 generates anomaly instance information based on the context information collected in step S111 and registers it to the anomaly instance information storage unit 173 (step S112). The process on the abnormal log to be determined then ends.

If the action content read in step S109 indicates other actions than disregard of the abnormal log (step S110, NO), the process on the abnormal log to be determined ends.

In general, even when abnormal logs of the same type are output, there are a case where it can be disregarded and a case where it cannot be disregarded, depending on a situation where the abnormal log was output, that is, a context. The log analysis system 100 according to the present example embodiment determines whether or not to disregard it based on context information on an abnormal log to be determined. Thus, an abnormal log can be automatically disregarded in accordance with a situation where the abnormal log was output. Furthermore, the log analysis system 100 automatically generates anomaly instance information from an abnormal log disregarded by a user and therefore can easily define anomaly instance information from the context information on the abnormal log.

### Second Example Embodiment

In the present example embodiment, in generation of anomaly instance information, logs or sequences which widely occur over time other than the time of output of an abnormal log are excluded from context information that is a basis of anomaly instance information. Thereby, determination can be made without using information which does not contribute to determination as to whether or not an abnormal log corresponds to a known anomaly instance, and thus the accuracy in determination can be improved.

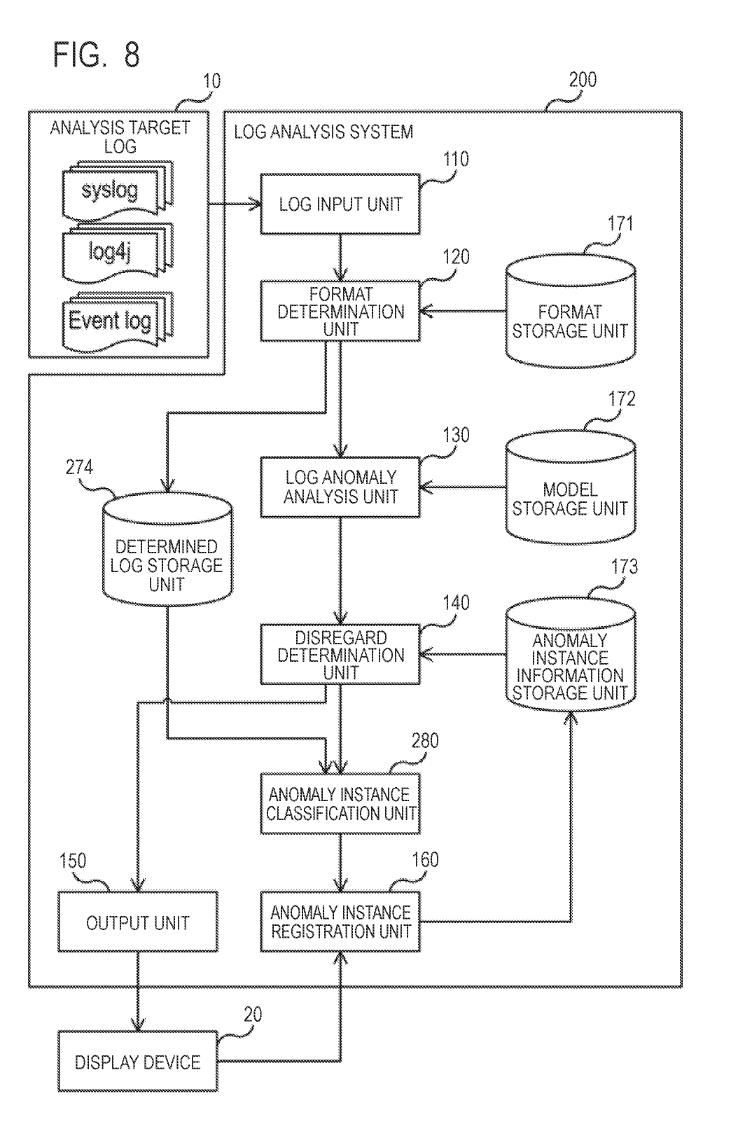

FIG. 8 is a block diagram of a log analysis system 200 according to the present example embodiment. The log analysis system 200 has an anomaly instance selection unit 280 that is a processing unit and a determined log storage unit 274 that is a storage unit, in addition to the configuration of FIG. 1.

The determined log storage unit 274 sequentially records and accumulates logs whose formats have been determined by the format determination unit 120 (that is, abnormal logs and normal logs). The anomaly instance selection unit 280 is provided in the pre-stage of the anomaly instance registration unit 160 and selects out information to be input to the anomaly instance registration unit 160 for generation of anomaly instance information based on the logs recorded in the determined log storage unit 274.

Specifically, the anomaly instance selection unit 280 excludes, from the previous logs in context information, logs corresponding to a format ID which widely occurs in the logs recorded in the determined log storage unit 274. A widely occurring format ID is a format ID whose occurrence per unit time (that is, occurrence frequency) is higher than or equal to a predetermined threshold, for example. Any other definitions may be used as the definition of a widely occurring format ID.

As another method, the anomaly instance selection unit 280 excludes, from the previous logs in context information, logs corresponding to a sequence which widely occurs in the logs recorded in the determined log storage unit 274. A widely occurring sequence is the permutation or the combination of a plurality of format IDs whose occurrence per unit time is higher than or equal to a predetermined threshold, for example. Any other definitions may be used as the definition of a widely occurring sequence. Further, both widely occurring format IDs and sequences may be excluded from the context information.

The anomaly instance registration unit 160 generates anomaly instance information on the disregarded abnormal log based on the context information whose content has been selected out by the anomaly instance selection unit 280 and registers it to the anomaly instance information storage unit 173.

The format and the sequence of logs widely occurring over time other than the time of output of an abnormal log are output regardless of an anomaly and thus do not contribute to determination as to whether or not it corresponds to an anomaly instance, and rather are highly likely to reduce the accuracy of determination. In the log analysis system 200 according to the present example embodiment, the anomaly instance registration unit 160 generates anomaly instance information from which the format or the sequence of logs widely occurring over time other than the time of output of an abnormal log has been excluded. Thus, the disregard determination unit 140 can determine whether or not an abnormal log to be determined corresponds to the past anomaly instance (that is, whether or not to automatically disregard it) without using information on the format or the sequence of logs widely occurring over time other than the time of output of an abnormal log.

### Third Example Embodiment

In the present example embodiment, in generation of anomaly instance information, only logs including a variable value included in an anomaly log and performance information and alive monitoring information on the variable value included in the abnormal log are used. Thereby, determination can be made by using only the information directly related to the content of the abnormal log to be determined, and thus the accuracy in determination can be improved.

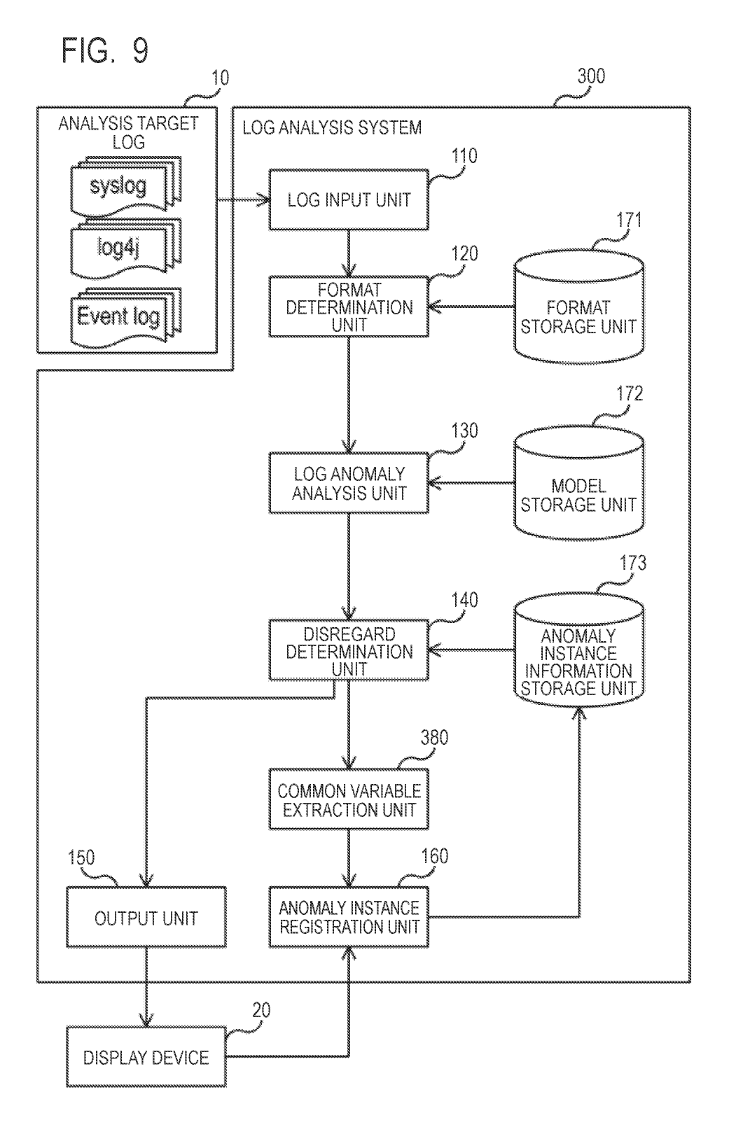

FIG. 9 is a block diagram of a log analysis system 300 according to the present example embodiment. The log analysis system 300 has a common variable extraction unit 380 that is a processing unit, in addition to the configuration of FIG. 1.

The common variable extraction unit 380 is provided in the pre-stage of the anomaly instance registration unit 160 and selects out information to be input to the anomaly instance registration unit 160 for generation of anomaly instance information based on a variable value included in an abnormal log to be determined.

Specifically, the common variable extraction unit 380 extracts a variable value from an abnormal log to be determined (referred to as a common variable value) based on the format determined by the format determination unit 120. At this time, the common variable extraction unit 380 may use all the variable values as the common variable value or may use some of the variable values selected based on a predetermined rule. For example, among the variable values in an abnormal log, only the variable value related to the component (a server, a network device, a virtual machine, an application, or the like) may be used.

The common variable extraction unit 380 then designates, as the previous log of the context information, a log including any of the common variable values out of the logs output within a predetermined time period (for example, within five minutes) before the time when an abnormal log was output. The previous log is not limited to the log on or before the time when the abnormal log was output and may be a log within a predetermined time period before or after the time as a reference. Further, the common variable extraction unit 380 designates, as performance information in the context information, the performance information (for example, the CPU usage) of a device matching any of the common variable values at the time when the abnormal log was output. Further, the common variable extraction unit 380 designates, as alive monitoring information in the context information, the alive monitoring information (for example, the suspended device) of a device matching any of the common variable values at the time when the abnormal log was output.

The anomaly instance registration unit 160 then generates anomaly instance information on the disregarded abnormal log based on the context information extracted by the common variable extraction unit 380 and registers it to the anomaly instance information storage unit 173.

In the log analysis system 300 according to the present example embodiment, the anomaly instance registration unit 160 generates anomaly instance information using only the logs including a variable value included in an abnormal log (common variable value) or performance information or alive monitoring information on a device matching the common variable value. Thus, the disregard determination unit 140 can determine whether or not an abnormal log to be determined corresponds to the past anomaly instance (that is, whether or not to automatically disregard it) by using only the information directly related to the abnormal log.

### Fourth Example Embodiment

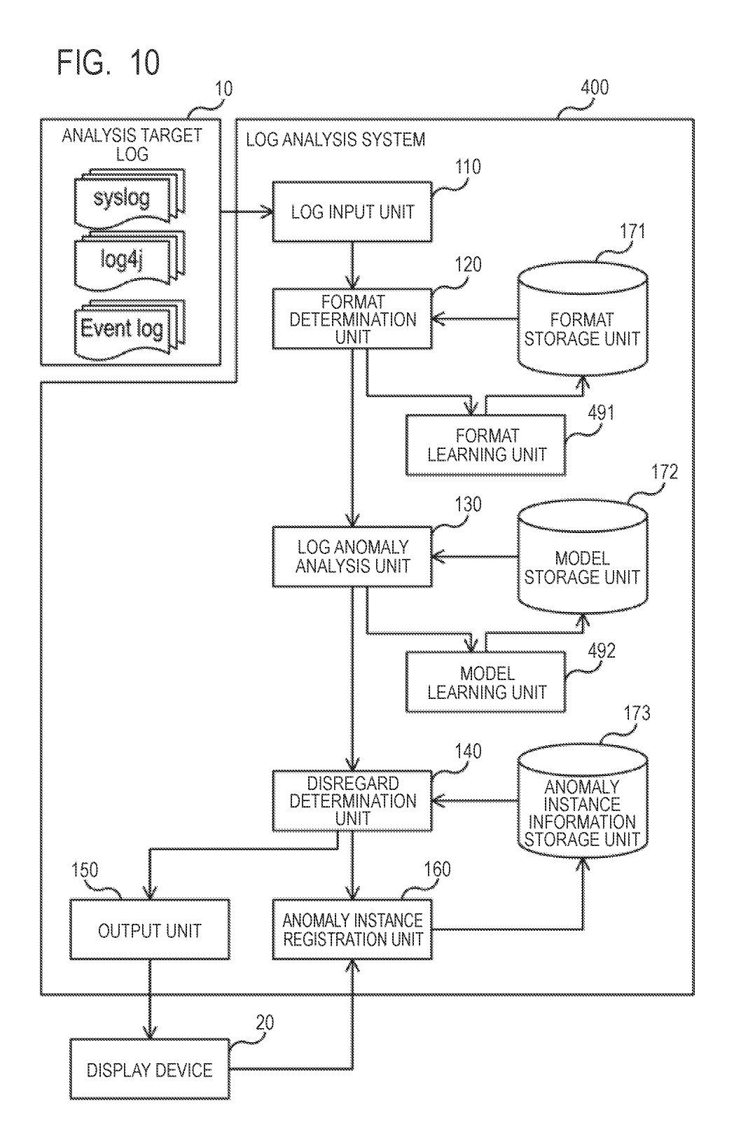

FIG. 10 is a block diagram of a log analysis system 400 according to the present example embodiment. The log analysis system 400 has a format leaning unit 491 and a model leaning unit 492 in addition to the configuration of FIG. 1.

When the format determination unit 120 determines the format and when a log to be determined does not conform to any of the formats recorded in the format storage unit 171, the format leaning unit 491 creates a new format and records the new format in the format storage unit 171.

As a first method for the format learning unit 491 to learn a format, the format learning unit 491 can define a new format by accumulating a plurality of logs whose formats are unknown and statistically separating the logs into changeable variable values and unchangeable constant parts. As a second method for the format learning unit 491 to learn a format, the format learning unit 491 can define a new format by reading a list of known variable values, determining, as a variable value, a part which is the same as or similar to the known variable value out of a log whose format is unknown, and determining other parts as a constant part. A value itself may be used as a known variable value, or a pattern such as normalized expression may be used. The learning method of a format is not limited to the above, and any learning algorithm that can define a new format for an input log may be used.

When the log anomaly analysis unit 130 determines the model and when a log to be determined does not conform to any of the models recorded in the model storage unit 172, the model leaning unit 492 creates a new model and records the new model in the model storage unit 172.

Typically, while the log anomaly analysis unit 130 determines, as an abnormal log, a log which does not conform to any of the models prerecorded in the model storage unit 172, even when a log is of an unknown model, such a log may be a normal log. In this case, when the user inputs via an input device an instruction indicating that a log that does not conform to any model in the model storage unit 172 is a normal log, the model learning unit 492 creates a new model based on the format and the variable value of the log and records the created model in the model storage unit 172. The learning method of a model is not limited to the above, and any learning algorithm that can define a new model for an input log may be used.

As discussed above, since the log analysis system 400 has learning units for a format and a model, it is possible to newly generate and record a format and a model from a log including unknown format and model.

### Other Example Embodiments

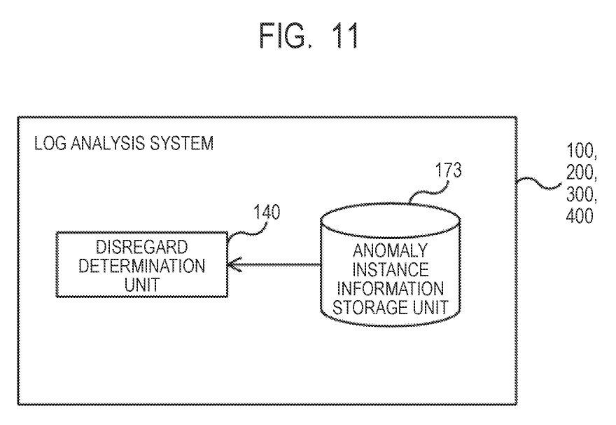

FIG. 11 is a general configuration diagram of each of the log analysis systems 100, 200, 300, and 400 according to each of the example embodiments described above. FIG. 11 illustrates a configuration example by which each of the log analysis systems 100, 200, 300, and 400 functions as a device that determines whether or not to disregard an abnormal log to be determined based on anomaly instance information. The log analysis systems 100, 200, 300, and 400 have the anomaly instance information storage unit 173 as a storage unit that records information indicating a situation where a log disregarded based on the past user input was output and the disregard determination unit 140 as a determination unit that, when information indicating a situation where a log to be determined was output is similar to the information indicating the situation where the disregarded log was output, determines to disregard the log to be determined.

The present invention is not limited to the example embodiments described above and can be properly changed within a scope not departing from the spirit of the present invention.

Further, the scope of each of the example embodiments includes a processing method that stores, in a storage medium, a program causing the configuration of each of the example embodiments to operate so as to realize the function of each of the example embodiments described above (more specifically, a program causing a computer to perform the process illustrated in FIG. 7), reads the program stored in the storage medium as a code, and executes the program in a computer. That is, the scope of each of the example embodiments includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A log analysis system comprising:

a storage unit that records information indicating a situation where a log disregarded based on a past user input was output; and

a determination unit that, when information indicating a situation where a log to be determined was output is similar to the information indicating the situation where the disregarded log was output, determines to disregard the log to be determined.

(Supplementary Note 2)

The log analysis system according to supplementary note 1 further comprising a registration unit that reads action content input by a user for the log to be determined and, when the action content indicates disregarding the log to be determined, records information indicating the situation where the log to be determined was output in the storage unit as the information indicating the situation where the disregarded log was output.

(Supplementary Note 3)

The log analysis system according to supplementary note 1 or 2 further comprising a form determination unit that determines which of a plurality of predetermined forms including a changeable variable part in the log to be determined and an unchangeable constant part in the log to be determined is matched to the log to be determined,

wherein the information indicating the situation where the log to be determined was output includes at least one of the form in the log to be determined and a value of the variable part in the log to be determined.

(Supplementary Note 4)

The log analysis system according to supplementary note 3,

wherein the form determination unit is further configured to determine which of the plurality of predetermined forms is matched to a plurality of logs output within a predetermined period with respect to a time when the log to be determined was output, and

wherein the information indicating the situation where the log to be determined was output includes a permutation or a combination of the forms of the plurality of logs.

(Supplementary Note 5)

The log analysis system according to supplementary note 4 further comprising:

a determined log storage unit that accumulates logs whose forms have been determined by the form determination unit; and

a selection unit that excludes, from the permutation or the combination of the forms of the plurality of logs, the form which occurs at a frequency that is higher than or equal to a predetermined threshold in logs accumulated in the determined log storage unit.

(Supplementary Note 6)

The log analysis system according to any one of supplementary notes 3 to 5 further comprising an extraction unit that extracts, from the information indicating the situation where the log to be determined was output, only information including the value of the variable part in the log to be determined.

(Supplementary Note 7)

The log analysis system according to any one of supplementary notes 1 to 6, wherein the information indicating the situation where the log to be determined was output includes at least one of performance information and alive monitoring information on a device related to the log to be determined.

(Supplementary Note 8)

A log analysis method comprising:

reading information indicating a situation where a log disregarded based on a past user input was output; and

when information indicating a situation where a log to be determined was output is similar to the information indicating the situation where the disregarded log was output, determining to disregard the log to be determined.

(Supplementary Note 9)

A log analysis program that causes a computer to perform:

reading information indicating a situation where a log disregarded based on a past user input was output; and

when information indicating a situation where a log to be determined was output is similar to the information indicating the situation where the disregarded log was output, determining to disregard the log to be determined.

This application is based upon and claims the benefit of priority from Japanese Patent Application No. 2015-242945, filed on Dec. 14, 2015, the disclosure of which is incorporated herein in its entirety by reference.

1. A log analysis system comprising:
a storage unit that records information indicating a situation where a log disregarded based on a past user input was output; and
a determination unit that, when information indicating a situation where a log to be determined was output is similar to the information indicating the situation where the disregarded log was output, determines to disregard the log to be determined.

2. The log analysis system according to claim 1 further comprising a registration unit that reads action content input by a user for the log to be determined and, when the action content indicates disregarding the log to be determined, records information indicating the situation where the log to be determined was output in the storage unit as the information indicating the situation where the disregarded log was output.

3. The log analysis system according to claim 1 further comprising a form determination unit that determines which of a plurality of predetermined forms including a changeable variable part in the log to be determined and an unchangeable constant part in the log to be determined is matched to the log to be determined,
wherein the information indicating the situation where the log to be determined was output includes at least one of the form in the log to be determined and a value of the variable part in the log to be determined.

4. The log analysis system according to claim 3,
wherein the form determination unit is further configured to determine which of the plurality of predetermined forms is matched to a plurality of logs output within a predetermined period with respect to a time when the log to be determined was output, and
wherein the information indicating the situation where the log to be determined was output includes a permutation or a combination of the forms of the plurality of logs.

5. The log analysis system according to claim 4 further comprising:
a determined log storage unit that accumulates logs whose forms have been determined by the form determination unit; and
a selection unit that excludes, from the permutation or the combination of the forms of the plurality of logs, the form which occurs at a frequency that is higher than or equal to a predetermined threshold in logs accumulated in the determined log storage unit.

6. The log analysis system according to claim 3 further comprising an extraction unit that extracts, from the information indicating the situation where the log to be determined was output, only information including the value of the variable part in the log to be determined.

7. The log analysis system according to claim 1, wherein the information indicating the situation where the log to be determined was output includes at least one of performance information and alive monitoring information on a device related to the log to be determined.

8. A log analysis method comprising:
reading information indicating a situation where a log disregarded based on a past user input was output; and
when information indicating a situation where a log to be determined was output is similar to the information indicating the situation where the disregarded log was output, determining to disregard the log to be determined.

9. A non-transitory storage medium in which a log analysis program is stored, the log analysis program causing a computer to perform:
reading information indicating a situation where a log disregarded based on a past user input was output; and
when information indicating a situation where a log to be determined was output is similar to the information indicating the situation where the disregarded log was output, determining to disregard the log to be determined.
